(19) United States
(12) Patent Application Publication
(10) Pub. No.: US 2026/0197858 A1
(43) Pub. Date: Jul. 9, 2026

(54) RADIO BASE STATION AND TERMINAL

(71) Applicant: NTT DOCOMO, INC., Tokyo (JP)

(72) Inventors: Tianyang MIN, Tokyo (JP); Shoki INOUE, Tokyo (JP); Anil UMESH, Tokyo (JP)

(73) Assignee: NTT DOCOMO, INC., Tokyo (JP)

(21) Appl. No.: 18/993,618

(22) PCT Filed: Jul. 22, 2022
(86) PCT No.: PCT/JP2022/028537

§ 371 Date: Jan. 13, 2025

(51) Int. Cl. H04W 72/566

(52) U.S. Cl. CPC H04W 72/566

(57) ABSTRACT

A radio base station includes: a transmission and reception unit that transmits and receives, a data set including a plurality of data units to which the degrees of importance are configured, to and from a terminal; and a control unit that discards a data unit to which the low degree of importance is configured among the plurality of data units, in which the control unit assigns, to the data unit, an identification number indicating a transmission order in the data set including the data unit.

### TECHNICAL FIELD

The present disclosure relates to a radio base station and a terminal that transmit and receive a data unit to which the degree of importance is configured.

### BACKGROUND ART

The 3rd Generation Partnership Project (3GPP) has prepared a specification for the 5th generation mobile communication system (also referred to as 5G, New Radio (NR), or Next Generation (NG)), and further a specification for a next-generation system referred to as Beyond 5G, 5G Evolution, or 6G is also being prepared.

3GPP Release 18 discusses the handling of extended Reality (XR) service-related traffic (Non-Patent Literature 1). In the past, Protocol Data Units (PDUs), which are data units transmitted and received in a Quality of Service (QOS) flow have been marked with the same QoS Flow Identification (QFI). As a result, the degrees of importance of all of the PDUs transmitted and received in the same QoS flow have been considered to be the same. Meanwhile, in XR, different sub QFIs are configured for PDUs transmitted and received in the same QoS flow according to the degrees of importance of the PDUs. This allows the PDUs transmitted and received in the same QoS flow to have different degrees of importance.

By using these sub QFIs, in XR in which low delay is required, discarding of a PDU with the low degree of importance is under investigation in a case of shortage of resources. (Non-Patent Literature 2).

### CITATION LIST

### Non-Patent Literature

Non-Patent Literature 1:“Study on XR Enhancements for NR”, RP-213587, 3GPP TSG RAN Meeting #94e, 3GPP, Dec. 6-17, 2021 Non-Patent Literature 2:“Reply LS on UE Power Saving for XR and Media Services”, R1-2205531, 3GPP TSG RAN WG 1#109-e, 3GPP, May 9, 20, 2022

### SUMMARY OF THE INVENTION

However, when actually discarding the PDU, it is necessary to clarify the relationship between the PDU to be discarded and a PDU set including the PDU in order to support discarding of the PDU.

The present disclosure has been made in view of such a situation, and an object of the present disclosure is to provide a radio base station and a terminal capable of clarifying the relationship between a PDU to be discarded and a PDU set including the PDU.

One aspect of the present disclosure provides a radio base station including: a transmission and reception unit 110 that transmits and receives, a data set including a plurality of data units to which the degrees of importance are configured, to and from a terminal; and a control unit 120 that discards a data unit to which the low degree of importance is configured among the plurality of data units, in which the control unit 120 assigns, to the data unit, an identification number indicating a transmission order in the data set including the data unit.

One aspect of the present disclosure provides a terminal including: a transmission and reception unit 210 that transmits and receives, a data set including a plurality of data units to which the degrees of importance are configured, to and from a radio base station; and a control unit 220 that discards a data unit to which the low degree of importance is configured among the plurality of data units, in which the control unit 220 assigns, to the data unit, an identification number indicating a transmission order in the data set including the data unit.

### BRIEF DESCRIPTION OF THE DRAWINGS

FIG. 1 is an overall schematic configuration diagram of a radio communication system 10.

FIG. 2 is a diagram showing a QoS architecture used in the radio communication system 10.

FIG. 3 is a diagram showing PDUs in a QoS flow.

FIG. 4 is a functional block diagram of a gNB 100 and a UE 200.

FIG. 5 is a diagram showing a protocol stack of the gNB 100 and the UE 200

FIG. 6 is a functional block diagram of control units 120 and 220 in a Service Data Adaptation Protocol (SDAP) layer.

FIG. 7 is a diagram showing a configuration example of SDAP-Config.

FIG. 8 is a diagram showing a configuration example of an SDAP header in DL.

FIG. 9 is a diagram showing a configuration example of an SDAP header in UL.

FIG. 10 is a functional block diagram of the control units 120 and 220 in a Packet Data Convergence Protocol (PDCP) layer/a Radio Link Control (RLC) layer/a Medium Access Control (MAC) layer.

FIG. 11 is a diagram showing that identification numbers are assigned to the PDUs in the QoS flow.

FIG. 12 is a diagram showing a configuration example of a PDCP header.

FIG. 13 is a diagram showing an example of a hardware configuration of the gNB 100 and the UE 200.

FIG. 14 is a diagram showing a configuration example of a vehicle 2001.

### DESCRIPTION OF EMBODIMENTS

An embodiment will be explained below with reference to the drawings. Note that the same or similar reference numerals have been attached to the same functions and configurations, and the description thereof will be omitted as appropriate.

### Embodiment

### (1) Overall Schematic Configuration of Radio Communication System

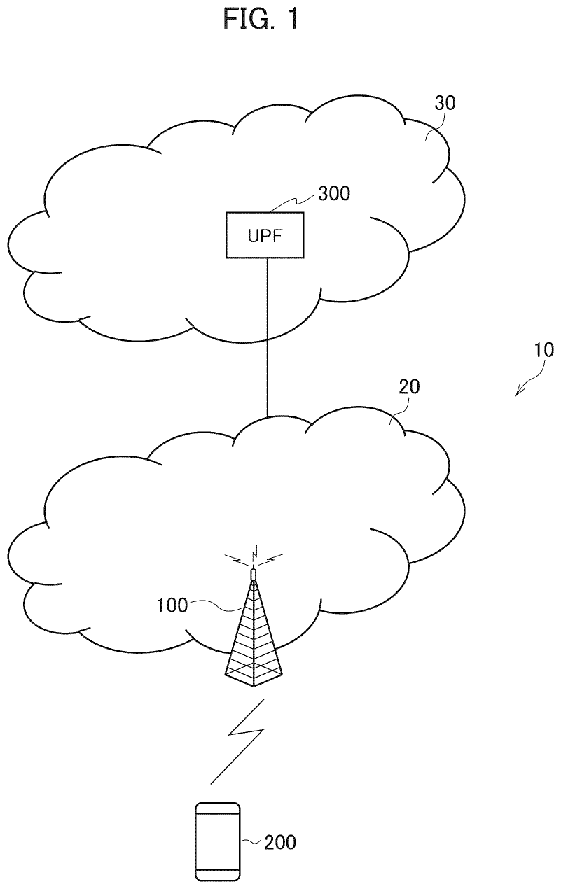

FIG. 1 is an overall schematic configuration diagram of a radio communication system 10 according to an embodiment. The radio communication system 10 is compliant with 5G New Radio (NR), and includes a Next Generation-Radio Access Network 20 (hereinafter referred to as NG-RAN 20), a terminal 200 (hereinafter referred to as UE 200), and a core network 30.

The radio communication system 10 may be compliant with a method referred to as Beyond 5G, 5G Evolution, or 6G.

The NG-RAN 20 includes a radio base station 100 (hereinafter referred to as gNB 100). The gNB 100 transmits and receives data units to and from the UE 200 via a plurality of radio bearers B1 and B2. A specific configuration of the radio communication system 10 including the number of gNBs 100 and UEs 200 is not limited to the example shown in FIG. 1.

The NG-RAN 20 actually includes a plurality of NG-RAN Nodes, specifically gNBs (or ng-eNBs), and is connected to the core network 30. The core network 30 includes a User Plane Function 300 (hereinafter referred to as UPF 300). The NG-RAN 20 and the core network 30 may simply be expressed as a “network”.

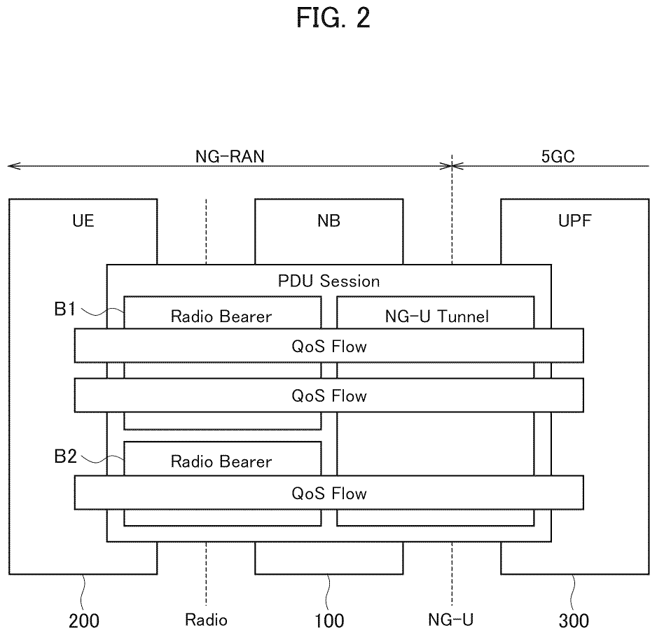

FIG. 2 shows a QoS architecture used in the radio communication system 10. The UE 200 and the UPF 300 map a PDU, which is a data unit received from an application/service layer (not shown), to a QoS flow. More specifically, the UE 200 maps UL PDUs, and the UPF 300 maps DL PDUs.

The PDU mapped to the QoS flow is marked with a QFI configured for the QoS flow. In other words, PDUs marked with the same QFI form each QoS flow. The PDU mapped to the QoS flow is transmitted and received between the gNB 100 and the UE 200 via the plurality of radio bearers B1 and B2. Therefore, the gNB 100 or the UE 200 maps the QoS flow to any of the plurality of radio bearers BI and B2.

In the embodiment, PDUs marked with the same QFI are further marked with a sub QFI according to the degree of importance of the PDUs. The sub QFI is an identifier indicating the degree of importance of the PDUs. This configures different degrees of importance for PDUs marked with the same QFI. Note that the sub QFI can be rephrased as Priority.

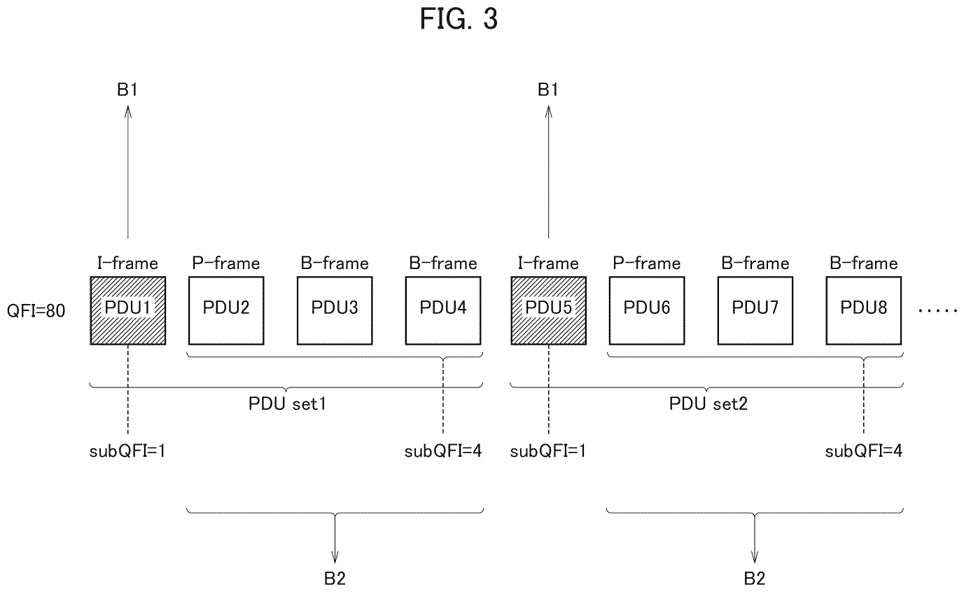

As shown in FIG. 3, even for PDUs with the same QFI=80, PDUs 1 and 5 of an I-flame are regarded to have the high degree of importance, and are marked with a sub QFI=1, for example. The I-flame is image data which is included in video data and which can be independently decoded. Meanwhile, PDUs 2, 3, and 4 of a P-flame and PDUs 6, 7, and 8of a B-flame are regarded to have the low degree of importance, and are marked with a sub QFI=4. The P-flame is image data which is included in video data and which indicates a difference with a previous I-flame. The B-flame is image data which is included in video data and which indicates a difference with previous and subsequent flames. Note that N of PDU N is also referred to as a PDU sequence number.

The gNB 100 or the UE 200 of the embodiment maps a PDU to any of the plurality of radio bearers B1 and B2, based on the sub QFI

### (2) Functional Block Configuration of Radio Communication System

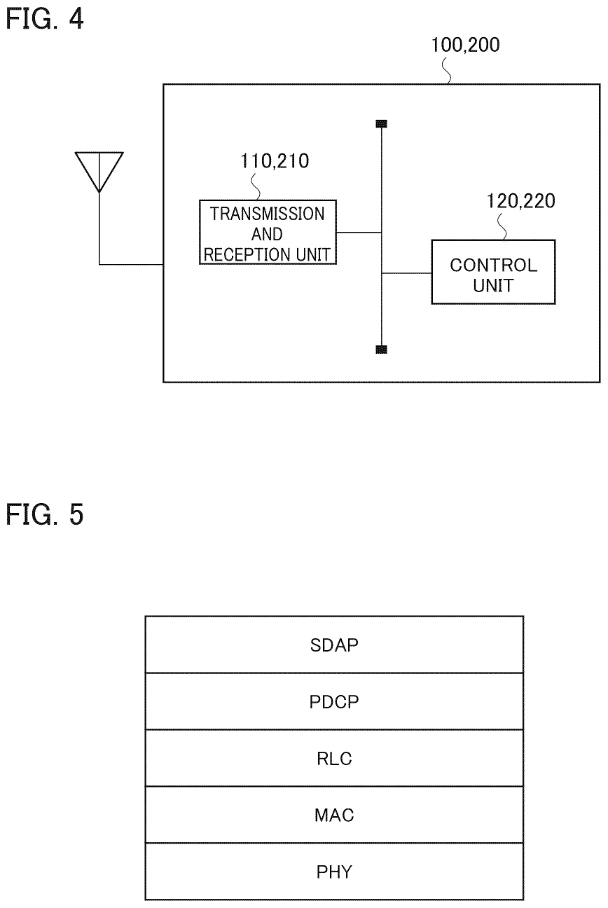

FIG. 4 is a functional block diagram of the gNB 100 and the UE 200. The gNB 100 includes a transmission and reception unit 110 and a control unit 120. The UE 200 includes a transmission and reception unit 210 and a control unit 220. The transmission and reception units 110 and 210 transmit and receive PDUs via the plurality of radio bearers B1 and B2. The control units 120 and 220 control transmission and reception of PDUs. For example, the control units 120 and 220 map the QoS flow to any of the plurality of radio bearers B1 and B2.

FIG. 5 is a diagram showing a protocol stack of the gNB 100 and the UE 200. A Service Data Adaptation Protocol (SDAP) layer is a higher layer of a Packet Data Convergence Protocol (PDCP) layer. The PDCP layer is a higher layer of a Radio Link Control (RLC) layer. The RLC layer is a higher layer of a Medium Access Control (MAC) layer. The MAC layer is a higher layer of PHYsical (PHY) layer.

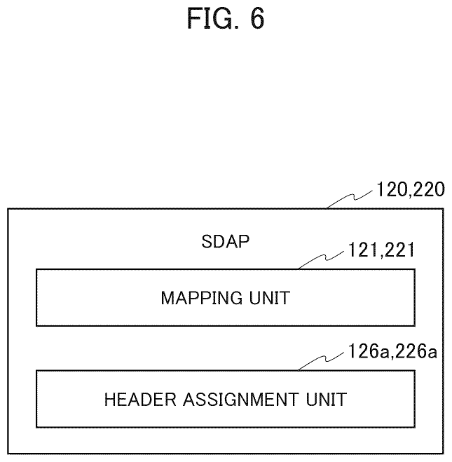

As shown in FIG. 6, the control unit 120 includes a mapping unit 121 and a header assignment unit 126a in the SDAP layer. The control unit 220 includes a mapping unit 221 and a header assignment unit 226a in the SDAP layer.

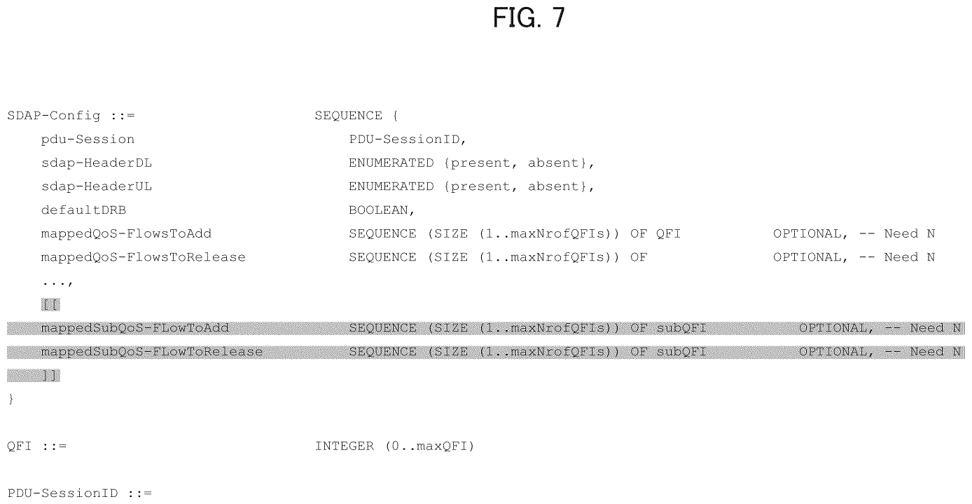

The mapping units 121 and 221 map a QoS flow to any of the plurality of radio bearers B1 and B2. Further, the mapping units 121 and 221 map a PDU to any of the plurality of radio bearers BI and B2. The mapping of the PDU by the mapping units 121 and 221 is performed based on a sub QFI marked on a PDU, as shown in FIG. 7, for example. FIG. 7 shows a configuration example of SDAP-Config.

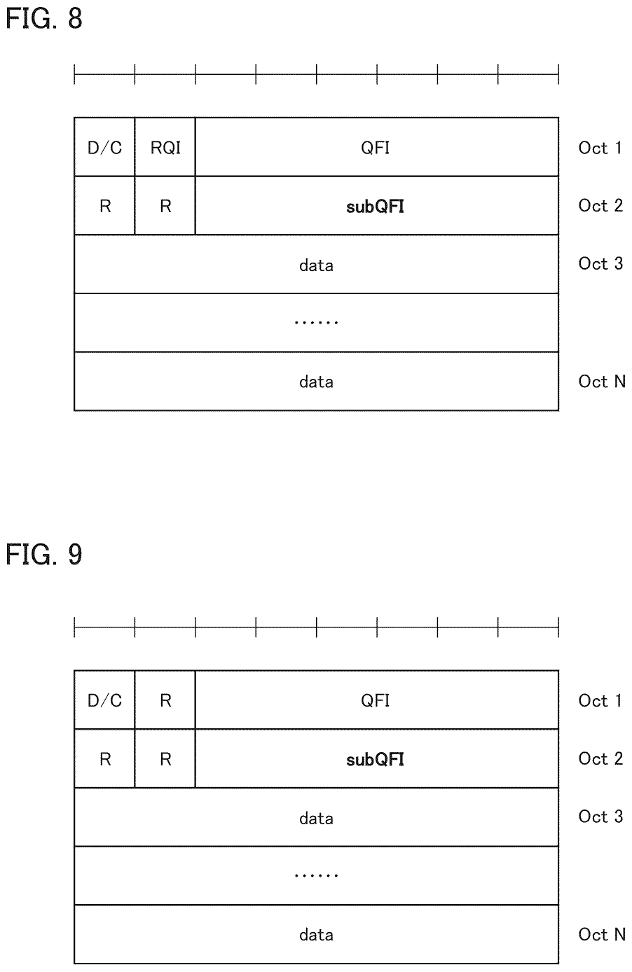

The header assignment units 126a and 226a assign an SDAP header to a PDU. The header assignment units 126a and 226a may add a sub QFI to the SDAP header, as shown in FIGS. 8 and 9, for example. Accordingly, the SDAP header assigned to the PDU includes the sub QFI which is an identifier indicating the degree of importance of the PDU. FIG. 8 shows a configuration example of an SDAP header in DL. Further, FIG. 9 shows a configuration example of an SDAP header in UL.

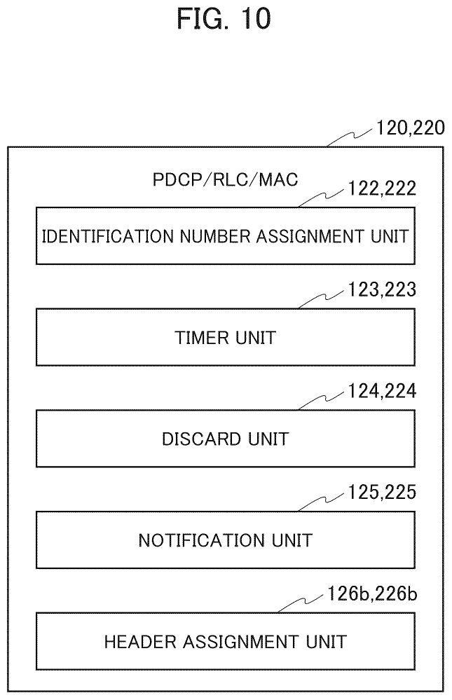

As shown in FIG. 10, the control unit 120 includes an identification number assignment unit 122, a timer unit 123, a discard unit 124, a notification unit 125, and a header assignment unit 126b in at least any of the PDCP layer, the RLC layer, and the MAC layer. The control unit 220 includes an identification number assignment unit 222, a timer unit 223, a discard unit 224, a notification unit 225, and a header assignment unit 226b in at least any of the PDCP layer, the RLC layer, and the MAC layer. Hereinafter, each unit in the PDCP layer will be described, but each unit may be read as each unit in the RLC layer or the MAC layer as appropriate.

The identification number assignment units 122 and 222 assign, to a PDU, an identification number indicating a relationship with a PDU set, which is a data set including the PDU. Specifically, the identification number assignment units 122 and 222 assign, to the PDU, an identification number indicating a transmission order in the PDU set including the PDU. A PDU set of the embodiment includes a plurality of adjacent PDUs.

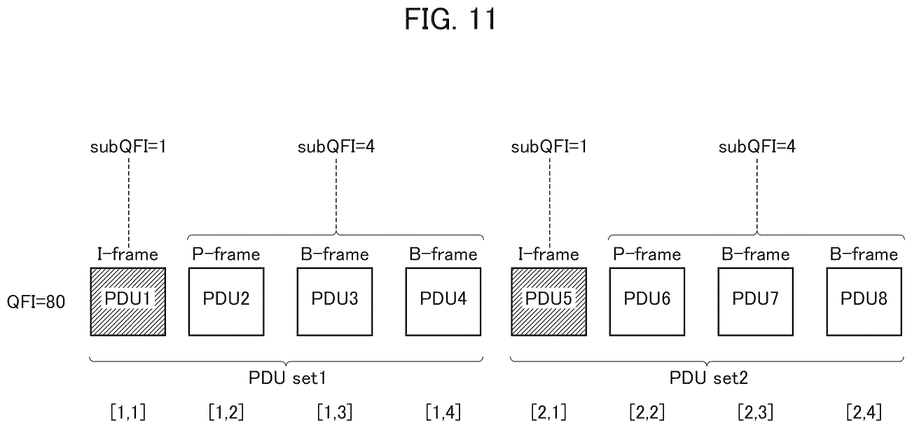

As shown in FIG. 11, identification numbers of [1,1], [1,2], [1,3], and [1,4] are assigned to PDU 1, PDU 2, PDU 3, and PDU 4 constituting PDU set 1, respectively according to the sequence number of the PDU set (N of PDU set N) and the transmission order in the PDU set, for example. Similarly, identification numbers of [2,1], [2,2], [2,3], and [2,4] are assigned to PDU 5, PDU 6, PDU 7, and PDU 8 constituting PDU set 2, respectively.

In FIG. 11, similarly to FIG. 3, PDU 1 and PDU 5 of an I-flame are marked with a sub QFI=1, PDU 2, PDU 3, and PDU 4 of a P-flame and PDU 6, PDU 7, and PDU 8 of a B-flame are marked with a sub QFI=4. In this way, the PDU set of the embodiment includes a mixture of PDUs (PDU 1 and PDU 5) to which the high degree of importance is configured, and PDUs (PDU 2, PDU 3, PDU 4, PDU 6, PDU 7, and PDU 8) to which the low degree of importance is configured.

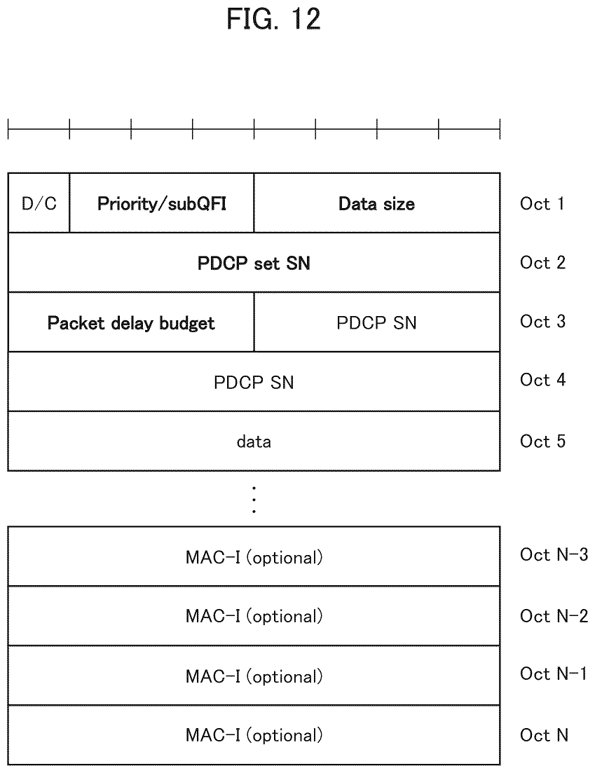

An identification number of the embodiment is indicated by an identifier which is referred to as PDU set SN. That is, the PDU set SN is an identifier indicating an identification number. The PDU set SN may be added to a PDCP header by header assignment units 126b and 226b, which will be described later (see FIG. 12). FIG. 12 shows PDCP set SN as the PDU set SN in accordance with the description of the PDCP header.

The timer units 123 and 223 configure a limit time to a PDU. The limit time is configured based on a delay request condition of the PDU, for example. The limit time of the embodiment is indicated by an identifier which is referred to as Packet delay budget. That is, the Packet delay budget is the identifier indicating the limit time. The Packet delay budget may be added to a PDCP header by the header assignment units 126b and 226b, which will be described later (see FIG. 12).

The discard units 124 and 224 may discard a PDU to which the low degree of importance is configured. A PDU to which the low degree of importance is configured may mean a PDU, to which the relatively low degree of importance is configured in the PDU set described above. In this case, the discard units 124 and 224 discard the PDU 2, PDU 3, and PDU 4 to which the degree of importance lower than that of the PDU 1 is configured in the PDU set 1 shown in FIG. 11, and the discard units 124 and 224 discard the PDU 6, PDU 7, and PDU 8 to which the degree of importance lower than that of the PDU 5 is configured in the PDU set 2.

The discard units 124 and 224 may discard a PDU to which the low degree of importance is configured, when a predetermined condition is satisfied. The predetermined condition may mean shortage of resources of the gNB 100 or the UE 200, for example.

The discard units 124 and 224 may discard a PDU which could not be transmitted within a limit time configured by the timer units 123 and 223. More specifically, the discard units 124 and 224 may discard a PDU which has not been transmitted from the PDCP layer to the RLC layer, which is a lower layer thereof, even after elapse of a limit time configured by the timer units 123 and 223. When the discard units 124 and 224 are disposed in the RLC layer, the discard units 124 and 224 may discard a PDU which has not been transmitted from the RLC layer to the MAC layer which is a lower layer thereof. Similarly, when the discard units 124 and 224 are disposed in the MAC layer, the discard units 124 and 224 may discard a PDU which has not been transmitted from the MAC layer to the PHY layer which is a lower layer thereof.

In this way, the discarding of a PDU by the discard units 124 and 224 may be based on the degree of importance configured in the PDU, may be based on the limit time configured in the PDU, or may be based on both the degree of importance and the limit time configured in the PDU.

The notification units 125 and 225 may notify the SDAP layer which is a higher layer of the PDCP layer, that the discard units 124 and 224 have discarded a PDU. Incidentally, if a PDU has been discarded in the RLC layer, the discarding of the PDU may be notified the PDCP layer which is a higher layer of the RLC layer. Similarly, if a PDU has been discarded in the MAC layer, the discarding of the PDU may be notified the RLC layer which is a higher layer of the MAC layer.

The header assignment units 126b and 226b assign a PDCP header to a PDU. The header assignment units 126b and 226b may add a sub QFI to a PDCP header, as shown in FIG. 12, for example. Accordingly, the PDCP header assigned to the PDU includes the sub OFI which is an identifier indicating the degree of importance of the PDU.

Further, the header assignment units 126b and 226b may add a PDU set SN (PDCP set SN) to the PDCP header. Accordingly, the PDCP header assigned to the PDU includes the PDU set SN (PDCP set SN) which is an identifier indicating an identification number indicating a transmission order of a PDU in a PDU set.

Further, the header assignment units 126b and 226b may add Packet delay budget to the PDCP header. Accordingly, the PDCP header assigned to the PDU includes the Packet delay budget which is an identifier indicating a limit time until the PDU is discarded.

Note that the header assignment units 126b and 226b may add the sub QFI, the PDU set SN, and the Packet delay budget to an RLC header or an MAC header.

### (3) Operation of Radio Communication System

Next, an operation of the radio communication system 10 will be described.

Specifically, a description will be given regarding an operation of mapping a PDU to any of the plurality of radio bearers B1 and B2 performed by the gNB 100 or the UE 200, an operation of configuring, to a PDU, an identification number indicating a relationship with a PDU set including the PDU, and an operation of configuring a limit time to a PDU and discarding the PDU which could not be transmitted within the limit time.

### (3.1) Issue

### (3.1.1) Issue 1

In XR, different sub QFIs are configured for PDUs marked with the same QFI according to the degrees of importance of the PDUs. Accordingly, the degrees of importance of the PDUs can be made different, even if the PDUs are transmitted and received in the same QoS flow. Meanwhile, there is a problem that the degrees of importance of the PDUs are not reflected in mapping to a radio bearer, because the mapping to the radio bearer is performed on a QoS flow basis.

### (3.1.2) Issue 2

In XR in which low delay is required, discarding of a PDU with the low degree of importance is under investigation in a case of shortage of resources. However, when actually discarding the PDU, it is necessary to clarify the relationship between the PDU to be discarded and a PDU set including the PDU, in order to support discarding of the PDU.

### (3.1.3) Issue 3

In XR in which low delay is required, a delay request condition may be configured to a PDU. There is no advantage in retransmitting a PDU which has failed to achieve the delay request condition, and therefore discarding the PDU is under investigation.

### (3.2) Operation Example

### (3.2.1) Operation Example 1

The gNB 100 or the UE 200 maps a PDU to any of the plurality of radio bearers B1 and B2 based on the degree of importance configured to the PDU. The degree of importance configured to the PDU is specified by a sub QFI As shown in FIG. 3, a sub QFI=1 is configured to the I-flame PDU 1 and PDU 5 with the high degree of importance, and a sub QFI=4 is configured to the P-flame PDU 2, PDU 3, and PDU 4 with the low degree of importance, and to the B-flame PDU 6, PDU 7, and PDU 8 with the low degree of importance, for example. That is, a PDU with the high degree of importance is marked with a sub QFI=1, and a PDU with the low degree of importance is marked with a sub QFI=4.

The gNB 100 or the UE 200 maps a PDU with the high degree of importance marked with a sub QFI=1 to the radio bearer B1, and maps a PDU with the low degree of importance marked with a sub QFI=4 to the radio bearer B2. More specifically, the mapping unit 121 or the mapping unit 221 maps a PDU with the high degree of importance marked with a sub QFI=1 to the radio bearer B1, and maps a PDU with the low degree of importance marked with a sub QFI=4 to the radio bearer B2.

The radio bearer BI may be handled preferentially compared to the radio bearer B2. For example, a higher logicalchannelPriority in RLC-bearerConfig may be configured to the radio bearer BI than to the radio bearer B2. As a result, scheduling may be performed preferentially for the radio bearer B1 compared to the radio bearer B2.

In mapping of PDUs, PDUs marked with the same sub QFI may be combined into one PDU. The PDU 2, PDU 3, and PDU 4 marked with a sub QFI=4 may be combined into one PDU, for example. In this case, the combined PDUs may be again marked with a sub QFI=4, and a PDU sequence number may be assigned again.

The gNB 100 or the UE 200 may add a sub QFI to a header assigned to a PDU. Specifically, the header assignment unit 126a or the header assignment unit 226a may add a sub QFI to an SDAP header assigned to a PDU. Further, the header assignment unit 126b or the header assignment unit 226b may add a sub QFI to a PDCP header, an RLC header, or an MAC header assigned to a PDU. Accordingly, a header assigned to a PDU includes a sub QFI which is an identifier indicating the degree of importance of the PDU.

### (3.2.2) Operation Example 2

The gNB 100 or the UE 200 assigns, to a PDU, an identification number indicating a relationship with a PDU set, which is a data set including the PDU. Specifically, the identification number assignment unit 122 or the identification number assignment unit 222 assigns, to a PDU, an identification number indicating a transmission order in a PDU set, which is a data set including the PDU.

As shown in FIG. 11, the identification number assignment unit 122 or the identification number assignment unit 222 assigns identification numbers of [1,1], [1,2], [1,3], and [1,4] to the PDU 1, PDU 2, PDU 3, and PDU 4 constituting the PDU set 1, respectively according to the sequence number of the PDU set (N of PDU set N) and the transmission order in the PDU set, for example. Similarly, the identification number assignment unit 122 or the identification number assignment unit 222 assigns identification numbers of [2,1], [2,2], [2,3], and [2,4] to the PDU 5, PDU 6, PDU 7, and PDU 8 constituting the PDU set 2, respectively.

The gNB 100 or the UE 200 discards a PDU to which the low degree of importance is configured. More specifically, the discard unit 124 or the discard unit 224 discards a PDU to which the low degree of importance is configured in at least any of the PDCP layer, the RLC layer, and the MAC layer, in a case of shortage of resources, for example. In the following description, a PDU to which the low degree of importance is configured means a PDU to which the relatively low degree of importance is configured in the PDU set described above. That is, the discard unit 124 or the discard unit 224 discards the PDU 2, PDU 3, and PDU 4 to which the degree of importance lower than that of the PDU 1 is configured in the PDU set 1 shown in FIG. 11, and the discard unit 124 or the discard unit 224 discards the PDU 6, PDU 7, and PDU 8 to which the degree of importance lower than that of the PDU 5 is configured in the PDU set 2. Note that the degree of importance configured to a PDU is specified by a sub QFI as in Operation Example 1.

The gNB 100 or the UE 200 may notify a higher layer of a layer in which a PDU is discarded, that the PDU has been discarded. When a PDU is discarded in the PDCP layer, the notification unit 125 or the notification unit 225 may notify the SDAP layer, which is a higher layer of the PDCP layer, that the PDU has been discarded, for example. Note that when a PDU is discarded in the RLC layer, the discarding of the PDU may be notified the PDCP layer which is a higher layer of the RLC layer. Similarly, when a PDU is discarded in the MAC layer, the discarding of the PDU may be notified the RLC layer which is a higher layer of the MAC layer.

The gNB 100 or the UE 200 may add a PDU set SN to a header assigned to a PDU. Specifically, the header assignment unit 126b or the header assignment unit 226b may add a PDU set SN (PDCP set SN) to a PDCP header assigned to a PDU. Similarly, the header assignment unit 126b or the header assignment unit 226b may add the PDU set SN to the RLC header or the MAC header. Accordingly, the header assigned to the PDU includes the PDU set SN, which is an identifier indicating an identification number indicating a transmission order of the PDU in a PDU set.

### (3.2.3) Operation Example 3

The gNB 100 or the UE 200 configures a limit time to a PDU. More specifically, the timer unit 123 or the timer unit 223 configures a limit time to a PDU. A limit time is configured based on a delay request condition of a PDU, for example.

When a PDU could not be transmitted within a limit time configured by the timer unit 123 or the timer unit 223, the gNB 100 or the UE 200 discards the PDU. More specifically, when a PDU could not be transmitted within the above-described limit time in any of the PDCP layer, the RLC layer, and the MAC layer, the discard unit 124 or the discard unit 224 discards the PDU.

The gNB 100 or the UE 200 may notify a higher layer of a layer in which a PDU is discarded, that the PDU has been discarded. When a PDU is discarded in the PDCP layer, the notification unit 125 or the notification unit 225 may notify the SDAP layer which is a higher layer of the PDCP layer, that the PDU has been discarded, for example.

Incidentally, when a PDU is discarded in the RLC layer, the discarding of the PDU may be notified the PDCP layer which is a higher layer of the RLC layer, Similarly, when a PDU is discarded in the MAC layer, the discarding of the PDU may be notified the RLC layer which is a higher layer of the MAC layer.

The gNB 100 or the UE 200 may add Packet delay budget to a header assigned to a PDU. Specifically, the header assignment unit 126b or the header assignment unit 226b may add Packet delay budget to a PDCP header assigned to a PDU. Similarly, the header assignment unit 126b or the header assignment unit 226b may add Packet delay budget to the RLC header or the MAC header. Accordingly, a header assigned to a PDU includes Packet delay budget which is an identifier indicating a limit time configured for the PDU.

### (4) Action and Effect

The gNB 100 or the UE 200 of the above-described embodiment maps a PDU to any of the plurality of radio bearers B1 and B2 based on the degree of importance configured for the PDU. This can reflects the degree of importance of the PDU in mapping to the plurality of radio bearers BI and B2.

Further, the gNB 100 or the UE 200 of the above-described embodiment assigns, to a PDU, an identification number indicating a transmission order in a PDU set including the PDU. This can clarify the relationship between the PDU and the PDU set, in order to support discarding of the PDU.

Further, the gNB 100 or the UE 200 of the above-described embodiment configures a limit time to a PDU, and discards the PDU which could not be transmitted within the limit time. Therefore, there is no risk of retransmitting the PDU which fails to achieve a delay request condition, and wasting resources, for example.

### (5) Other Embodiments

Although contents of the present invention have been described in accordance with the embodiment, it is obvious to those skilled in the art that the present invention is not limited to the descriptions, and that various modifications and improvements thereof are possible.

In the above disclosure, the radio communication system based on XR has been described, but the present disclosure is not limited thereto. XR refers to a composite environment of a real environment and a virtual environment generated by a computer. XR, however, is not limited to this kind of XR, and the radio communication system of the above embodiment may be applied to streaming music, streaming video, and the like, In the above disclosure, a PDU may be read as a Service Data Unit (SDU).

In the above disclosure, the number of the plurality of radio bearers B1 and B2 is two, but the number may be three or more.

In the above disclosure, the number of sub QFIs, which are identifiers indicating the degrees of importance, is two, but the number may be three or more. An I-flame PDU may be marked with a sub QFI=1, a P-flame PDU may be marked with a sub QFI=4, and a B-flame PDU may be marked with a sub QFI=7, for example. In this case, the degree of importance of the PDU marked with a sub QFI=1 may be regarded to be high, and the degree of importance of the PDUs marked with a sub QFI=4 and a sub QFI=7 may be regarded to be low.

In the above disclosure, a PDU to which the low degree of importance is configured means a PDU, to which the relatively low degree of importance is configured in the PDU set described above, but the present disclosure is not limited thereto. A. PDU to which the low degree of importance is configured may mean a PDU to which the degree of importance lower than the predetermined degree of importance is configured, for example. In this case, assuming that the predetermined degree of importance is a sub QFI=2, the discard units 124 and 224 discard the PDU 2, PDU 3, PDU 4, PDU 6, PDU 7, and PDU 8 marked with a QFI=4 in FIG. 11, for example.

In the above disclosure, one PDU set includes a mixture of PDUs to which the high degrees of importance are configured, and PDUs to which the low degrees of importance are configured, but the present disclosure is not limited thereto. That is, the degrees of importance of PDUs constituting one PDU set may be the same. If the low degrees of importance are configured to such PDUs, the discard units 124 and 224 may discard the PDU set instead of discarding each PDU.

In the above disclosure, the discard units 124 and 224 discard a PDU based on at least one of the degree of importance and a limit time configured to the PDU, but the present disclosure is not limited thereto. The discard units 124 and 224 may discard a PDU based on the PDU data size, for example. The PDU data size is indicated by an identifier which is referred to as Data size. That is, the Data size is an identifier indicating the PDU data size. The Data size may be included in a PDU header by the header assignment units 126b and 226b (see FIG. 12).

Further, an indicator indicating that a PDU may be discarded may be configured to the PDU. The discard units 124 and 224 may discard the PDU to which the indicator is configured. Still further, the discard units 124 and 224 may discard a PDU to which the indicator is configured and which could not be transmitted within a configured limit time.

In the above disclosure, the timer unit 123 and the discard unit 124 are disposed in at least any of the PDCP layer, the RLC layer, and the MAC layer, the timer unit 123 configures a limit time to a PDU in each layer, and the discard unit 124 discards the PDU which has not been transmitted within the limit time, but the present disclosure is not limited thereto. If the gNB 100 includes a Central Unit (CU) and a Distributed Unit (DU), the timer unit 123 and the discard unit 124 may be disposed in a buffer of the DU, for example. That is, a PDCP PDU transmitted from the CU is stored in the buffer of the DU before being processed in an RLC layer of the DU. In the buffer, a limit time may be configured for the PDU and the PDU which has not been transmitted within the limit time may be discarded.

In the above disclosure, the notification units 125 and 225 notify a higher layer of a layer in which a PDU is discarded, that the PDU has been discarded, but the present disclosure is not limited thereto. That is, the notification units 125 and 225 may notify a lower layer of a layer in which a PDU is discarded, that the PDU has been discarded. Further, when the gNB 100 includes a CU and a DU, the notification unit 125 may notify the DU of a PDU discarded in the CU using U-plane signaling. The U-plane signaling may be DL User DATA (PDU Type 0) associated with a Downlink PDCP PDU, for example.

In the above disclosure, the discarding of a PDU is notified by the notification units 125 and 225, but the present disclosure is not limited thereto. The discarding of the PDU may be notified by the header assignment units 126b and 226b, for example. Specifically, an identifier indicating that a PDU has been discarded may be added to a header such as a PDCP header.

In the above disclosure, the PDU set SN is an identifier indicating an identification number, but the present disclosure is not limited thereto. The PDU set SN may be an identifier indicating a sequence number of a PDU set, for example. In this case, a function as the identification number can be realized by combining the sequence number with a sequence number of a PDU.

The notification unit 125 may notify the UE 200 of a sequence number of a discarded PDU or PDU set. Similarly, the notification unit 225 may notify the gNB 100 of a sequence number of a discarded PDU or PDU set. Further, the UE 200 may notify the gNB 100 of a sequence number of a discarded PDU or PDU set by means of PDCP status report. This eliminates a risk of a sequence number deviation of a PDU or a PDU set, which has been discarded, between the gNB 100 and the UE 200.

The notification unit 125 may notify the UE 200 of a count value of a discarded PDU or PDU set. Similarly, the notification unit 225 may notify the gNB 100 of a count value of a discarded PDU or PDU set. Further, the UE 200 may notify the gNB 100 of a count value of a discarded PDU or PDU set by means of PDCP status report. The count value is necessary for generating a security key stream (integrity, ciphering). If the count value is deviated, the security key stream does not match between the gNB 100 and the UE 200. Therefore, as described above, by notifying a count value of a discarded PDU or PDU set, it is possible to solve a problem that the security key stream does not match.

When the gNB 100 or the UE 200 discards a PDU, the gNB 100 or the UE 200 may perform L2 measurement and statistically record the frequency or rate at which the PDU is discarded. The UE 200 may notify a network of the recorded frequency or rate at which the PDU is discarded.

The operation examples described above may be combined and applied compositely as long as there is no contradiction.

In the above disclosure, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, UE-common, and UE-shared may be read interchangeably.

The block diagrams (FIGS. 4, 6 and 10) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but the functions are by no means limited to these. For example, a functional block (component) to implement a function of transmission may be referred to as a “transmitting section (transmitting unit),” a “transmitter”. The method for implementing each component is not particularly limited as described above.

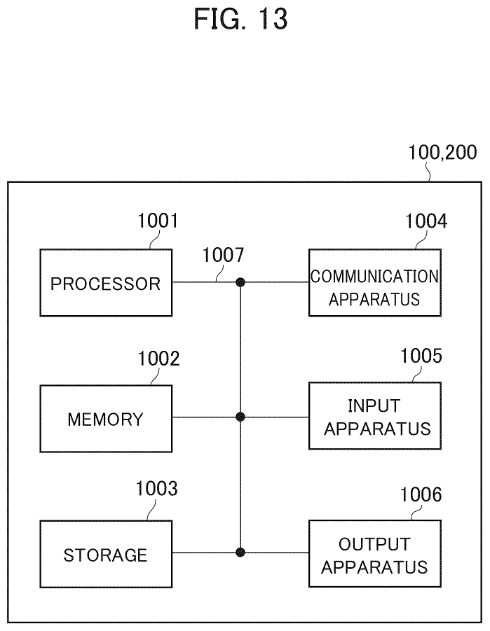

Furthermore, the above-described gNB 100 and UE 200 (the apparatus) may function as a computer that executes the processes of the radio communication method of the present disclosure. FIG. 13 is a diagram to show an example of a hardware structure of the apparatus. As shown in FIG. 13, the apparatus may each be formed as a computer apparatus that includes a processor 1001, a memory 1002, a storage 1003, a communication apparatus 1004, an input apparatus 1005, an output apparatus 1006, a bus 1007, and so on.

Note that in the following description, the word such as an apparatus can be read as a circuit, a device, a section, a unit, and so on. The hardware structure of the apparatus may be configured to include one or more of apparatuses shown in the drawings, or may be configured not to include part of apparatuses.

Each function of the apparatus (see FIGS. 4, 6 and 10) is implemented by one of hardware elements or the combination of the hardware elements in the computer apparatus.

Each function of the apparatus is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The above-described various processes may be performed by a single processor 1001, or may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), and so on. The memory 1002 may be referred to as a “register,” a “cache,” a “main memory (primary storage apparatus)” and so on. The memory 1002 can store executable programs (program codes), software modules, and the like for implementing the method according to one embodiment of the present disclosure.

The storage 1003 is a computer-readable recording medium, and may be constituted with, for example, at least one of a compact disc (Compact Disc ROM (CD-ROM) and so on), a hard disk drive, a flexible disk, a magneto-optical disk (for example, a compact disc, a digital versatile disc, a Blu-ray (registered trademark) disk), a smart card, a flash memory device (for example, a card, a stick, and a key drive), a floppy (registered trademark) disk, a magnetic stripe, and so on. The storage 1003 may be referred to as “auxiliary storage apparatus.” The above recording medium may be a database including at least one of the memory 1002 and the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that performs output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, pieces of apparatus, including the processor 1001, the memory 1002, and others, are connected by a bus 1007 for communicating information. The bus 1007 may be formed with a single bus, or may be formed with buses that vary between pieces of apparatus.

Also, the apparatus may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information may be implemented by using physical layer signaling (for example, downlink control information (DCI), uplink control information (UCI), higher layer signaling (for example, RRC signaling, Medium Access Control (MAC) signaling), broadcast information (master information block (MIB), system information block (SIB)), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), New radio access (NX), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate systems, next-generation systems that are enhanced based on these. A plurality of systems may be combined (for example, a combination of at least one of LTE and LTE-A, and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Specific operations which have been described in the present disclosure to be performed by a base station may, in some cases, be performed by an upper node thereof.

In a network including one or a plurality of network nodes with the base station, it is clear that various operations that are performed to communicate with a terminal can be performed by the base station and other network nodes (for example, Mobility Management Entities (MMEs), Serving-Gateways (S-GWs), and so on may be possible, but these are not limiting) other than the base station, or combinations of these. According to the above, a case is described in which there is a single network node other than the base station. However, a combination of multiple other network nodes may be considered (e.g., MME and S-GW).

The information or signals may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A determination may be realized by a value (0 or 1) represented by one bit, by a boolean value (true or false), or by comparison of numerical values (e.g., comparison with a predetermined value).

Each aspect/embodiment described in the present disclosure may be used independently, may be used in combination, or may be used by switching according to operations. Further, notification of predetermined information (e.g., notification of “X”) is not limited to an explicit notification, and may be performed by an implicit notification (e.g., by not performing notification of the predetermined information).

Software should be broadly interpreted to mean, regardless of whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) and wireless technologies (infrared, microwave, etc.), at least one of these wired line technologies or wireless technologies is included within the definition of the transmission medium.

Information, a signal, or the like, described in the present disclosure may be represented by using any one of various different technologies. For example, data, an instruction, a command, information, a signal, a bit, a symbol, a chip, or the like, referred to throughout the above description, may be represented by a voltage, an electric current, electromagnetic waves, magnetic fields, a magnetic particle, optical fields, a photon, or a combination thereof.

It should be noted that a term described in the present disclosure and/or a term required for understanding of the present disclosure may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations.

Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNodeB (eNB),” a “gNodeB (gNB),” an “access point,” a “transmission point,” a “reception point,” a “transmission/reception point,” a “cell,” a “sector,” a “cell group,” a “carrier,” a “component carrier,” and so on can be used interchangeably. A base station may be referred to as the terms such as a “macro cell,” a “small cell,” a “femto cell,” a “pico cell,” and so on.

A base station can accommodate one or a plurality of (for example, three) cells (which may be referred to as sectors). When a base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases by the skilled person in the art.

At least one of a base station and a mobile station may be referred to as a “transmitting apparatus,” a “receiving apparatus,” a “communication apparatus,” and so on. Note that at least one of a base station and a mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IOT) device such as a sensor.

Furthermore, a base station in the present disclosure may be interpreted as a mobile station (user terminal, hereinafter the same). For example, each aspect/embodiment of the present disclosure may be applied to the structure that replaces a communication between a base station and a mobile station with a communication between a plurality of mobile stations (for example, which may be referred to as “Device-to-Device (D2D),” “Vehicle-to-Everything (V2X),” and the like). In this case, the mobile station may have the functions of the base station described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, a mobile station in the present disclosure may be interpreted as a base station. In this case, the base station may have the functions of the mobile station described above.

A radio frame may be constituted of one or a plurality of frames in the time domain. Each of one or a plurality of frames may be referred to as a “subframe” in the time domain.

Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of the number of symbols less than a slot. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “TTI,” a plurality of consecutive subframes may be referred to as a “TTI,” or one slot or one mini-slot may be referred to as a “TTI” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG), ”a “PRB pair,” an “RB pair” and so on.

Furthermore, a resource block may be constituted of one or a plurality of resource elements (REs). For example, one RE may be a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP” Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of one or more wires, cables, and printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot”, depending on which standard is applied.

The phrase “based on” as used in the present disclosure does not mean “based only on”, unless otherwise specified. In other words, the phrase “based on” means both “based only on” and “based at least on”.

“Means” included in the configuration of each of the above apparatuses may be replaced by “parts”, “circuits”, “devices”, etc.

Reference to elements with designations such as “first,” “second,” and so on used in the present disclosure does not generally limit the quantity or order of these elements.

These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present disclosure is not intended to be an “exclusive or”.

In the present disclosure, in the case where an article is added by translation, for example “a”, “an”, and “the”, the disclosure may include that the noun following these articles is plural.

As used in the present disclosure, the term “determining” may encompasses a wide variety of actions. For example, “determining” may be regarded as determining to have performed judging, calculating, computing, processing, deriving, investigating, looking up (looking up, search, inquiry) (e.g., looking up in a table, a database or another data structure), ascertaining and the like. Also, “determining” may be regarded as determining to have performed receiving (e.g., receiving information), transmitting (e.g., transmitting information), inputting, outputting, accessing (e.g., accessing data in a memory) and the like. Also, “determining” may be regarded as determining to have performed resolving, selecting, choosing, establishing, comparing and the like. That is, “determining” may be regarded as determining to have performed some action. Moreover, “determining” may be read as “assuming”, “expecting”, “considering”, and the like.

In this disclosure, the term “A and B are different” may mean “A and B are different from each other.” It should be noted that the term “A and B are different” may mean “A and B are different from C.” Terms such as “separated” or “combined” may be interpreted in the same way as the “different”.

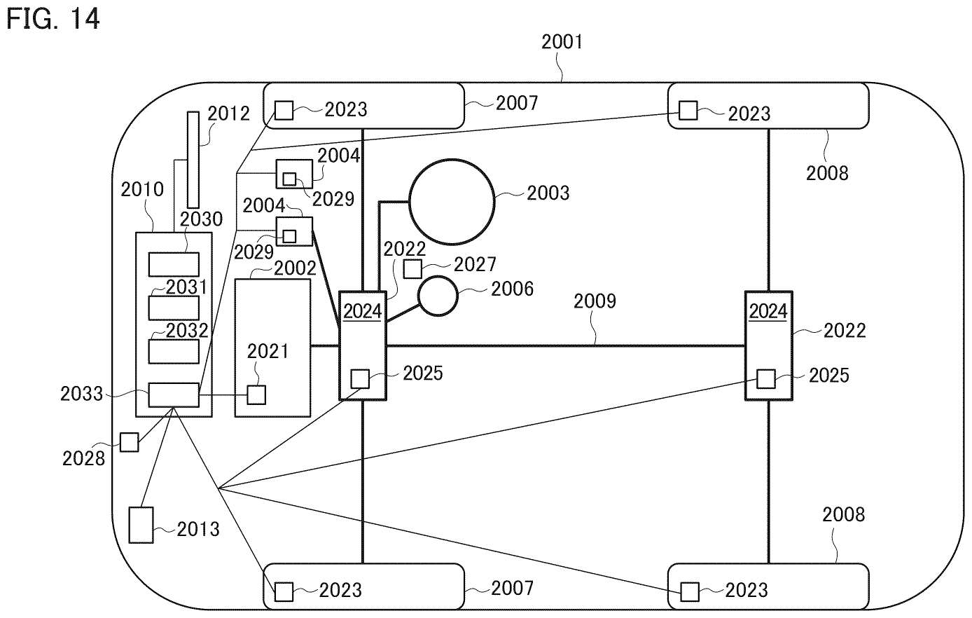

FIG. 14 shows an example of a configuration of a vehicle 2001. As shown in FIG. 14, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021-2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-29 provided in the vehicle. The electronic control unit 2010 may be referred to as an ECU (Electronic Control Unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

A driving support system unit 2030 includes: various devices for providing functions of preventing accidents and reducing driver's operating loads such as a millimeter wave radar, a LIDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the left and right front wheels 2007, the left and right rear wheels 2008, the axle 2009, the microprocessor 2031 and the memory (ROM, RAM) 2032 in the electronic control unit 2010, and the sensors 2021 to 2028 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits a current signal from a current sensor, which is input to the electronic control unit 2010, to external devices through radio communication. Also, the communication module 2013 transmits to external devices through radio communication, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like, which are input to the electronic control unit 2010.

The communication module 2013 receives various types of information (traffic information, signal information, inter-vehicle information, etc.) transmitted from the external devices and displays the received information on the information service unit 2012 provided in the vehicle 2001. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the left and right front wheels 2007, the left and right rear wheels 2008, the axle 2009, the sensors 2021-2028, etc., mounted in the vehicle 2001.

### Supplementary Notes

The radio base station or the terminal of the embodiment may be configured as a radio base station or a terminal shown in each supplementary note below.

### Section 1

A radio base station including:
a transmission and reception unit that transmits and receives, a data set including a plurality of data units to which the degrees of importance are configured, to and from a terminal; and
a control unit that discards a data unit to which the low degree of importance is configured among the plurality of data units, in which
the control unit assigns, to the data unit, an identification number indicating a transmission order in the data set including the data unit.

### Section 2

The radio base station according to claim 1, in which
a header assigned to the data unit includes an identifier indicating the identification number.

### Section 3

The radio base station according to claim 1 or 2, in which
the control unit discards the data unit in a lower layer of a Service Data Adaptation Protocol (SDAP) layer.

### Section 4

The radio base station according to claim 3, in which
the control unit notifies a higher layer of a layer in which the data unit is discarded that the data unit has been discarded.

### Section 5

The radio base station according to any one of claims 1 to 4, in which
the control unit configures a limit time to the data unit, and discards the data unit that could not be transmitted within the limit time.

### Section 6

A terminal including:
a transmission and reception unit that transmits and receives, a data set including a plurality of data units to which the degrees of importance are configured, to and from a radio base station; and
a control unit that discards a data unit to which the low degree of importance is configured among the plurality of data units, in which
the control unit assigns, to the data unit, an identification number indicating a transmission order in the data set including the data unit.

As described above, the present disclosure has been described in detail. It is apparent to a person skilled in the art that the present disclosure is not limited to one or more embodiments described in the present disclosure. The present disclosure can be implemented as modifications and variations without departing from the subject matter and the scope of the present disclosure defined by the descriptions of claims. Therefore, the descriptions of the present disclosure are for illustrative purposes only, and are not intended to be any limitations to the present disclosure.

### REFERENCE SIGNS LIST

B1, B2 Radio bearer
10 Radio communication system
20 NG-RAN
30 Core network
100 gNB
110 Transmission and reception unit
120 Control unit
121 Mapping unit
122 Identification number assignment unit
123 Timer unit
124 Discard unit
125 Notification unit
126a, 126b Header assignment unit
200 UE
210 Transmission and reception unit
220 Control unit
221 Mapping unit
222 Identification number assignment unit
223 Timer unit
224 Discard unit
225 Notification unit
226a, 226b Header assignment unit
300 UPF
1001 Processor
1002 Memory
1003 Storage
1004 Communication apparatus
1005 Input apparatus
1006 Output apparatus
1007 Bus
2001 Vehicle
2002 Drive unit
2003 Steering unit
2004 Accelerator pedal
2005 Brake pedal
2006 Shift lever
2007 Left and right front wheels
2008 Left and right rear wheels
2009 Axle
2010 Electronic control unit
2012 Information service unit
2013 Communication module
2021 Current sensor
2022 Rotation speed sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port

1. A radio base station comprising:
a transmission and reception unit that transmits and receives, a data set including a plurality of data units to which the degrees of importance are configured, to and from a terminal; and
a control unit that discards a data unit to which the low degree of importance is configured among the plurality of data units, wherein
the control unit assigns, to the data unit, an identification number indicating a transmission order in the data set including the data unit.

2. The radio base station according to claim 1, wherein
a header assigned to the data unit includes an identifier indicating the identification number.

3. The radio base station according to claim 1, wherein
the control unit discards the data unit in a lower layer of a Service Data Adaptation Protocol (SDAP) layer.

4. The radio base station according to claim 3, wherein
the control unit notifies a higher layer of a layer in which the data unit is discarded that the data unit has been discarded.

5. The radio base station according to claim 1, wherein
the control unit configures a limit time to the data unit, and discards the data unit that could not be transmitted within the limit time.

6. A terminal comprising:
a transmission and reception unit that transmits and receives, a data set including a plurality of data units to which the degrees of importance are configured, to and from a radio base station; and
a control unit that discards a data unit to which the low degree of importance is configured among the plurality of data units, wherein
the control unit assigns, to the data unit, an identification number indicating a transmission order in the data set including the data unit.
